(19) United States
(12) Patent Application Publication
(10) Pub. No.: US 2003/0229669 A1
(43) Pub. Date: Dec. 11, 2003

(54) Device for notification of receipt of email

(76) Inventors: Jen-Fu Chen, Feng Yuan City (TW); Chih-Shen Chen, Taichung (TW)

Correspondence Address: Alan D. Kamrath, Rider, Bennett, Egan & Arundel, LLP, 333 South Seventh Street, Suite 2000, Minneapolis, MN, 55402, US

(21) Appl. No.: 10/166,149

(22) Filed: Jun. 10, 2002

(51) Int. Cl. G06F 15/16

(52) U.S. Cl. 709/206

(57) ABSTRACT

A system includes a computer for receiving emails and sending a signal after receiving an email and a device for receiving the signal from the computer and notifying of the receipt of the email. The device includes a casing, a circuit board received in the casing for electric connection with the computer and a signaling element in electric connection with the circuit board. A central processor unit is installed on the circuit board. The signaling element is a speaker or a luminescent strip. In an aspect, the device includes a wire leading from the circuit board. A plug is formed at an end of the wire. In another aspect, the device includes a wireless transmitter for electric connection with the personal computer and sending a wireless signal and a wireless receiver in electric connection with the circuit board and for receiving the wireless signal.

### BACKGROUND OF INVENTION

1. Field of Invention

The present invention relates to a device for notification of receipt of an email.

2. Related Prior Art

Personal computers are popular in modem societies. A lot of people send and receive emails through Internet by means of their personal computers. However, when a user is not sitting in front of his or her personal computer, the user cannot be aware of receipt of an email by means of the personal computer. If the email carries an urgent and important that must be addressed immediately, the user misses the best timing to review and respond to it.

The present invention is therefore intended to obviate or at least alleviate the problem encountered in prior art.

### SUMMARY OF INVENTION

It is an objective of the present invention to provide a device for notification of receipt of an email.

According to the present invention, a system includes a computer for receiving emails and sending a signal after receiving an email and a device for receiving the signal from the computer and notifying of the receipt of the email.

The device includes a casing, a circuit board received in the casing for electric connection with the computer and a signaling element in electric connection with the circuit board. A central processor unit is installed on the circuit board. The signaling element is a speaker or a luminescent strip.

In an aspect, the device includes a wire leading from the circuit board. A plug is formed at an end of the wire.

In another aspect, the device includes a wireless transmitter for electric connection with the personal computer and sending a wireless signal and a wireless receiver in electric connection with the circuit board and for receiving the wireless signal.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings wherein:

FIG. 1 is a perspective view of a device for notification of receipt of an email according to an embodiment of the present invention;

FIG. 2 is an exploded view of the device shown in FIG. 1;

FIG. 3 is a perspective view of a personal computer used together with the device shown in FIGS. 1 and 2; and

FIG. 4 is a perspective view of a personal computer used together with a device for notification of receipt of an email according to another embodiment of the present invention.

### DETAILED DESCRIPTION OF EMBODIMENTS

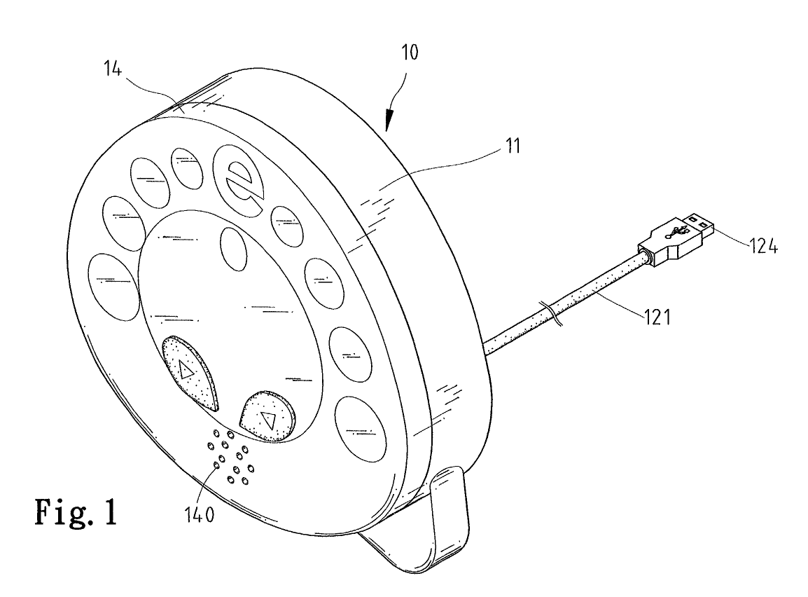

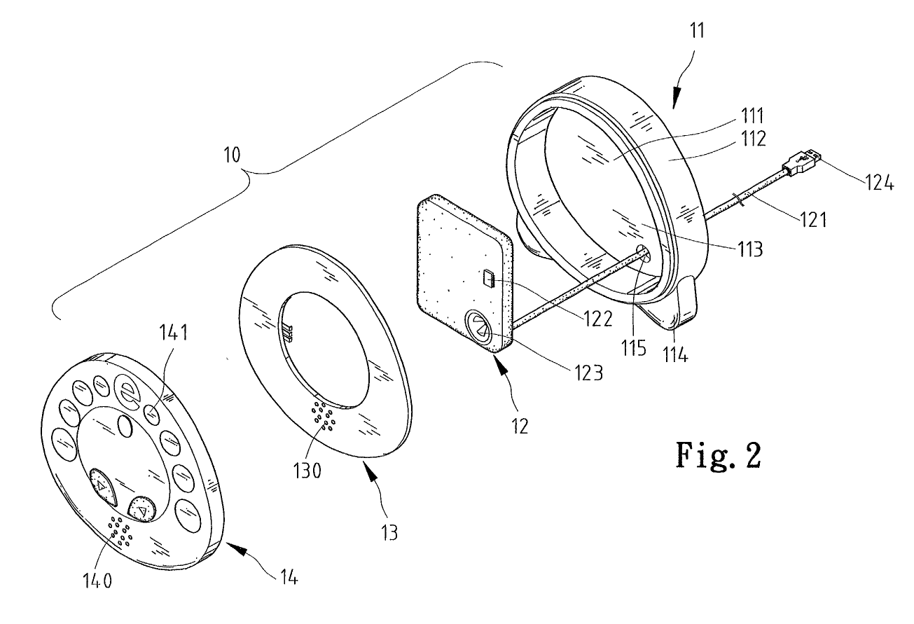

Referring to FIGS. 1 and 2, according to a first embodiment of the present invention, a device 10 for notification of receipt of an email includes a casing 11, a circuit board 12, a luminescent strip 13 and a panel 14.

Like a casing of an alarm clock, includes a periphery 12, a back plate 113 formed on a rear side of the periphery 12 and two legs 114 extending from a lower portion of the periphery 12. A space 111 is defined by means of the periphery 12 and the back plate 13. The back plate 113 defines an aperture 115 in communication with the space 111.

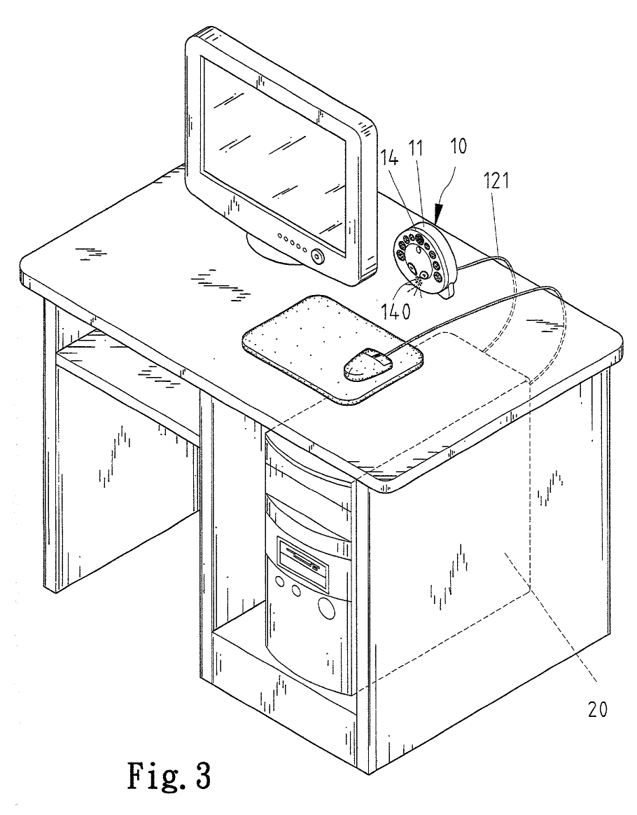

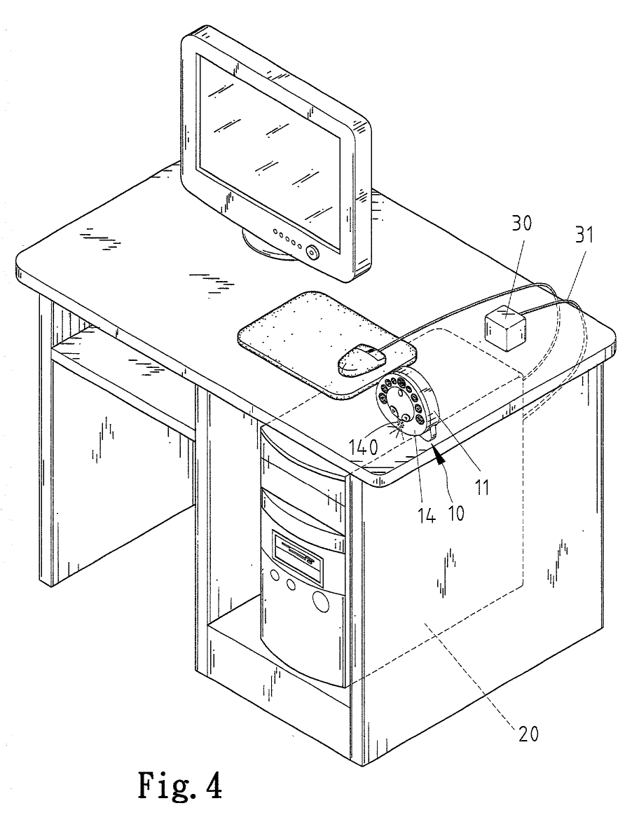

The circuit board 12 is received in the space 111. The circuit board 12 includes a wire leading from the circuit board 12, a central processor unit (“CPU”) 122 installed thereon and a speaker 123 installed thereon. The wire 121 is formed with a plug 124 at an end. The wire 121 is inserted through the aperture 115 so that the plug 124 can be put in engagement with a port of a personal computer as shown in FIGS. 3 and 4.

The luminescent strip 13 is in electric connection with the circuit board 12. The electric connection of the luminescent strip 13 with the circuit board 12 however will not be described in detail for being conventional. The luminescent strip 13 defines a plurality of apertures 130. The luminescent strip 13 is received in the space 111 or located against a front end of the casing 11. The apertures 130 are positioned in front of the speaker 123. Thus, voices produced by means of the speaker 123 can be easily transmitted through the apertures 130.

The panel 14 defines a plurality of apertures 140 corresponding to the apertures 130. The apertures 140 are positioned in front of the apertures 130 when the panel 14 is mounted on the front end of the casing 11. Thus, voices produced by means of the speaker 123 can be easily transmitted through the apertures 140. The panel 14 defines a plurality of windows 141. Each of the windows 141 may be an opening or an opening covered by means of a transparent lens. Thus, light emitted by means of the luminescent strip 13 can be seen through the windows 141.

Referring to FIG. 3, the device 10 can be put in electric connection with a personal computer (“PC”) 20 through electric connection of the plug 124 with an appropriate port (not shown) formed on the personal computer 20. After receiving an email, the PC 20 sends a signal to the device 10. After receiving the signal, the device 10 activates the speaker 123 to produce voices and the luminescent strip 13 to emit light in order to notify a user of the PC 20 of the receipt of the email.

FIG. 4 shows an apparatus for notification of receipt of an email according to a second embodiment of the present invention. The apparatus includes a device 10′ and a wireless transmitter 30. The wireless transmitter 30 includes a wire 31 for electric connection with the PC 20. The device 10′ is similar to the device 10 except for including a wireless receiver (not shown), instead of the wire 121, corresponding to the wireless transmitter 30. The wireless receiver is in electric connection with the circuit board 12. After receiving an email, the PC 20 sends a signal to the wireless transmitter 30. After receiving the signal, the wireless transmitter 30 sends a wireless signal to the wireless receiver installed in the device 10′. Then, the device 10′ activates the speaker 123 to produce voices and the luminescent strip 13 to emit light in order to notify a user of the PC 20 of the receipt of the email.

The present invention has been described via detailed illustration of two embodiments. Those skilled in the art can derive many variations from the embodiments without departing from the scope of the present invention. Therefore, the embodiments shall not limit the scope of the present invention. The scope of the present invention is defined in the attached claims.

1. A system including a computer (20) for receiving emails and sending a signal after receiving an email and a device for receiving the signal from the computer and notifying of the receipt of the email.

2. The system according to claim 1 wherein the device includes a casing (11), a circuit board (12) received in the casing (11) for electric connection with the computer (20) and a signaling element (123; 13) in electric connection with the circuit board (12).

3. The system according to claim 2 wherein the signaling element is a speaker (123).

4. The system according to claim 2 wherein the signaling element is a luminescent strip (13).

5. The system according to claim 2 wherein the circuit board (12) includes a central processor unit (122) installed thereon.

6. The system according to claim 2 wherein the device (10) includes a wire (121) leading from the circuit board (12).

7. The system according to claim 6 wherein the device (10) includes a plug (124) formed at an end of the wire 121.

8. The system according to claim 2 wherein the device includes a wireless transmitter (30) for electric connection with the personal computer (20) and sending a wireless signal and a wireless receiver in electric connection with the circuit board (12) and for receiving the wireless signal.
